(19) United States
(12) Patent Application Publication
(10) Pub. No.: US 2026/0242656 A1
(43) Pub. Date: Aug. 20, 2026

(54) NANO CLAY MINERAL-BASED DRILLING MUD AND METHOD FOR PRODUCING SAME

(71) Applicants: Korea University Research and Business Foundation, Seoul (KR); Industry-academic Cooperation Foundation Gyeongsang National university, Jinju-si (KR); Korea Institute of Geoscience and Mineral Resources, Daejeon (KR)

(72) Inventors: Soo-Young KIM, Seoul (KR); Sung-Hyun HONG, Seoul (KR); Wook-Ryol HWANG, Jinju-si (KR); Hae-Jin JO, Jinsu-si (KR); Young-Ju KIM, Jinju-si (KR); Nam-Sub WOO, Pohang-si (KR); Sang-Mok HAN, Pohang-si (KR)

(73) Assignees: Korea University Research and Business Foundation, Seoul (KR); Industry-academic Cooperation Foundation Gyeongsang National university, Jinju-si (KR); Korea Institute of Geoscience and Mineral Resources, Daejeon (KR)

(21) Appl. No.: 18/707,673

(22) PCT Filed: Nov. 4, 2022
(86) PCT No.: PCT/KR2022/017237

§ 371 Date: May 6, 2024

(30) Foreign Application Priority Data
Nov. 5, 2021 (KR) 10-2021-0151005

(51) Int. Cl. C09K 8/14

(52) U.S. Cl. CPC C09K 8/145

(57) ABSTRACT

The present invention relates to a drilling fluid based on a nano-clay mineral and a manufacturing method thereof and, more specifically, to a drilling fluid based on a nano-clay mineral which comprises a solvent and smectite clay mineral nanoparticles, wherein the solvent is distilled water or salt water, the smectite clay mineral nanoparticles have a size of 10 nm-10 micrometers, and 90 wt-99.9 wt % to 0.1 wt % to 10 wt % of the smectite clay mineral nanoparticles are mixed with each other; and a manufacturing method having a manufacturing process of processing with ultrasonic waves or a homomixer for the same.

### TECHNICAL FILED

The present invention relates to a drilling fluid used for drilling and a manufacturing thereof and, more specifically, to a drilling fluid based on nano-clay minerals and a method for manufacturing the same, wherein the drilling fluid provides the drilling fluid based on the nano-clay minerals, increases viscosity with respect to the same used weight, improves shear thinning, and improves physical properties with higher concentration while using less amount than existing methods.

### BACKGROUND ART

Drilling fluid generally refers to a fluid used in drilling, which is a work of digging deep holes in the ground, and performs various roles including transporting a rock piece of a stratum coming out of drilling to the outside of the stratum, maintaining a pore pressure of the borehole, preventing water leaching of an inner wall of the borehole, lubricating and cooling the bit, and the like.

Examples of the drilling fluid may include an aqueous-based, an oil-based, and a synthetic-based, and, while the oil-based drilling fluid and the synthetic-based drilling fluid can be used in a high temperature and high pressure environment, the water-based drilling fluid has an advantage of being expensive and eco-friendly.

Here, the aqueous-based drilling fluid has a configuration in which bentonite, barite, and a polymer thickener are included in water in the related art, and, among them, bentonite is a clay mineral which is made of volcanic ash and has swelling properties, and is the most important material performing various roles such as determining rheological properties such as viscosity and yield stress of drilling fluid and preventing water leakage.

The bentonite used as a core material of drilling fluid has been developed to utilize various advantages, such as high temperature and high pressure, as well as enhanced shear thinning in which a low viscosity value is obtained at a low shear end and a low viscosity value is obtained at a high shear end, by using the bentonite prepared from a microscale to a nanoscale.

According to the conventional technology for preparing drilling fluid, a nano-scale bentonite is prepared by ball milling and used as the drilling fluid, but, the conventional method using the ball milling has a relatively long processing time and a difficulty in collecting the sample, and also has a problem in that the size of the nanoparticles is non-uniform, and thus a more efficient and mass-producible solution is required.

Meanwhile, for drilling fluid and a manufacturing technology thereof, PCT International Application PCT/EP2017/066988 discloses “an organic clay composition using a compound including an amine salt of trimeric acid and an amine salt of monocarboxylic fatty acid and the use thereof”, and Chinese Patent Application Publication No. CN 109504354 discloses “Drilling fluid wherein a lubricant includes a carrier oil, an extreme pressure agent, an organic molybdenum compound, and an adsorption film forming agent, and the mass ratio of the carrier oil, the extreme pressure agent, the organic molybdenum compound, and the adsorption film forming agent is (60-80):(10-20):(5-15):(2-8)”, which is incorporated by reference.

### DETAILED DESCRIPTION OF THE INVENTION

### Technical Problem

The present invention has been made in an effort to provide a nano-clay mineral-based drilling fluid and a method for preparing the same, wherein the drilling fluid provides a nano-clay mineral-based drilling fluid, wherein the drilling fluid can increase viscosity with respect to the same used weight, can improve shear thinning, and can have improved physical properties of a higher concentration while using a smaller amount of the drilling fluid than a conventional rig.

The purpose of the present invention is to provide a nano-clay mineral-based drilling fluid and a method for manufacturing the same, wherein the drilling fluid enables easy preparation of a powder or liquid drilling fluid having a nanoparticle size using an ultrasonic wave or a homomixer, and enables a clay mineral which is a core material to have a uniform nanoparticle size.

The purpose of the present invention is to provide nano-clay mineral-based drilling fluid water and a manufacturing method thereof, capable of mass-producing in a short time compared with the existing one.

### Technical Solution

In order to achieve the above object, the present invention provides a nano-clay mineral-based drilling fluid comprising a solvent and smectite-group clay mineral nanoparticles, wherein the solvent is distilled water or salt water, and the smectite-group clay mineral nanoparticles have a size of 10 nm to 10 μm.

In addition, in order to achieve the above object, the method for preparing drilling fluid based on nano-clay minerals according to the present invention is characterized by comprising the steps of: (A) making a suspension by mixing smectite group clay minerals with a solvent, and aging the suspension for 24 hours to 48 hours for viscosity and dispersion stabilization; and (B) making smectite group clay mineral nanoparticles by putting the suspension in an ultrasonic wave ratio, and then sonicating the suspension with ultrasonic intensity of 60 W to 70 W for 2 hours to 10 hours to make the smectite group clay minerals in the suspension into nanoparticles.

In addition, in order to achieve the above object, the method for preparing drilling fluid based on nano-clay minerals according to the present invention is characterized by comprising the steps of: (A) making a suspension liquid by mixing smectite group clay minerals with a solvent, and aging the suspension liquid for 24 hours to 48 hours for viscosity and dispersion stabilization; and (B) making smectite group clay mineral nanoparticles by putting the suspension liquid into a homomixer, and then performing mixing for 2 hours to 4 hours under the condition of energy dissipation 10³ W/kg to 10⁶ W/kg of the homomixer to make the smectite group clay minerals in the suspension liquid into nanoparticles.

Here, the size of the smectite-based clay mineral nanoparticles may be 10 nm to 10 μm.

In order to achieve the above objects, various embodiments exist for each characteristic, and these various embodiments will be described in more detail below.

### Effects of the Invention

According to the present invention, the present invention can provide a drilling fluid based on nano-clay minerals, wherein the drilling fluid can increase viscosity with respect to the same used weight, can improve shear thinning, and can have improved physical properties with a higher concentration while using a smaller amount than an existing one.

According to the present invention, it is possible to simply and easily prepare a drilling fluid in a powder or liquid state having a nanoparticle size using an ultrasonic wave or a homomixer, and it is possible to provide a drilling fluid having a uniform nanoparticle size for a clay mineral which is a core material.

According to the present invention, the present invention can be produced in large quantities in a short time compared to conventional methods, and can provide drilling fluid having a sufficient concentration to be directly used as drilling fluid after 48 hours of waiting after ultrasonic or homomixer treatment.

### BRIEF DESCRIPTION OF THE DRAWINGS

FIG. 1 is a process flowchart illustrating a method for preparing drilling fluid based on a nano-clay mineral according to an embodiment of the present invention.

FIG. 2 is a process flowchart provided to explain a method for preparing drilling fluid based on a nano-clay mineral according to another embodiment of the present invention.

FIG. 3 is a mimetic diagram illustrating a method for preparing drilling fluid based on nano-clay minerals according to the present invention, wherein (a) is a mimetic diagram illustrating an ultrasonic treatment method and (b) is a mimetic diagram illustrating a homomixer treatment method.

FIG. 4 is a photograph showing an electric field emission type scanning electron microscope image of nano-bentonite according to ultrasonic treatment in the method for manufacturing a drilling fluid based on nano-clay minerals according to the present invention.

FIG. 5 is a photograph showing an electric field emission type scanning electron microscope image of nano-bentonite according to treatment of a stator-rotor type homomixer in the method for preparing drilling fluid based on nano-clay minerals according to the present invention.

FIG. 6 is a photograph showing an electric field emission type scanning electron microscope image of nano bentonite according to the blade type homomixer treatment in the method for preparing drilling fluid based on nano-clay minerals according to the present invention.

FIG. 7 is a photograph showing a transmission electron microscopy image of bentonite for comparison of the present invention, which is an image showing bentonite treated with normal bentonite and sonicated or homomixer treated.

FIG. 8 is a graph showing a particle distribution of nano-bentonite according to the homomixer treatment in the method for preparing drilling fluid based on nano-clay minerals according to the present invention.

FIG. 9 is a graph illustrating particle crystallinity of nano-bentonite by sonication or homomixer treatment in the method for preparing drilling fluid based on nano-clay minerals according to the present invention.

FIG. 10 is a graph showing a viscosity value according to shear stress of a drilling fluid produced by mixing a nano bentonite powder produced by ultrasonic treatment with distilled water in the method for producing a drilling fluid based on a nano-clay mineral according to the present invention.

FIG. 11 is a graph showing viscosity values according to shear stress of nano bentonite drilling fluid manufactured by processing a stator-rotor type homomixer in the method for manufacturing drilling fluid based on nano-clay minerals according to the present invention.

FIG. 12 is a graph showing a viscosity value according to shear stress of nano bentonite drilling fluid manufactured by blade-type homomixer treatment in the method for manufacturing the drilling fluid based on the nano-clay mineral according to the present invention.

FIG. 13 is a main part configuration diagram illustrating a stator-rotor type homomixer in the method for manufacturing a drilling fluid based on a nano-clay mineral according to the present invention.

FIG. 14 is a view showing a hydrodynamic mechanism of a stator-rotor type homomixer side and a numerical analysis result in the method for preparing drilling fluid based on a nano-clay mineral according to the present invention.

### BEST MODE FOR CARRYING OUT THE INVENTION

Exemplary embodiments of the present invention will be described below with reference to the accompanying drawings, and the objects and configurations of the present invention and the features thereof will be better understood through the detailed description.

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters. In other examples, well-known structures and devices are illustrated in a block diagram in order to facilitate describing one or more aspects.

Further, a term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims

FIG. 1 to FIG. 14 are drawings and image photographs provided to explain a method for preparing a nano-clay mineral-based drilling fluid and a method for preparing the same according to an embodiment of the present invention.

The nano-clay mineral-based drilling fluid according to an embodiment of the present invention is configured to include a solvent and smectite-based clay mineral nanoparticles.

It is preferable to use distilled water or salt water in order to enhance the exclusive thinning phenomenon on the drilling fluid side.

Here, the solvent is 90 wt % to 99.9 wt %, and the smectite clay mineral nanoparticles include 0.1 wt % to 10 wt %.

Here, the solvent and the smectite clay mineral nanoparticles may have a different mixing ratio according to a treatment method such as ultrasonic waves or a homomixer in the following preparation method.

Here, the size of the smectite-based clay mineral nanoparticles may be 10 nm to 10 μm.

In this case, the smectite-based clay mineral may be one or more selected from the group consisting of bentonite, montmorillonite, saponite, hectorite, minnesotaite, nontronite, and beidelite.

As described above, the nano-clay mineral-based drilling fluid including the solvent and the smectite-based clay mineral nanoparticles according to the present invention may be provided in a powder or liquid type.

Here, the powdered drilling fluid may be added to distilled water or salt water while maintaining a certain concentration when used in the drilling, and the liquid drilling fluid may be used immediately or after aging, as necessary.

The nano-clay mineral-based drilling fluid which can be provided in a powder or liquid form and comprises a solvent and smectite-group clay mineral nanoparticles according to the present invention can be simply prepared through a preparation method which will be described below, and can be mass-produced in a short time.

As shown in FIG. 1 and FIG. 3A, the method for preparing drilling fluid based on nano-clay minerals according to an embodiment of the present invention may include a step S10 of preparing and aging a suspension liquid, a step S20 of treating ultrasonic waves, and a step S30 of drying and powdering.

The suspension liquid preparation and aging step (S10) is a step in which a smectite clay mineral is mixed with a solvent to prepare a suspension coal solution, and then aged for 24 hours to 48 hours for viscosity and dispersion stabilization.

The solvent may be used in an amount of 97 wt % to 99.9 wt %, and the smectite clay mineral may be mixed in an amount of 0.1 wt % to 3 wt %.

The smectite-based clay mineral may be one or more selected from the group consisting of bentonite, montmorillonite, saponite, hectorite, minnesotaite, nontronite, and beidelite.

The ultrasonic treatment step (S20) is a step of nano-granulating the particles of the smectite-based clay minerals in the smectite-based clay mineral suspension liquid, and is a step of injecting the suspension liquid, which has undergone the suspension liquid preparation and aging step S10, into an ultrasonic wave ratio and then performing ultrasonic treatment.

Specifically, the ultrasonic treatment step (S20) is a step of putting the suspension liquid containing smectite-based clay minerals into an ultrasonic wave ratio and then performing ultrasonic treatment at an ultrasonic intensity of 60 W to 70 W for 2 hours to 10 hours.

The ultrasonic treatment is preferably performed at a cycle of applying an ultrasonic wave for 3 seconds and resting for 2 seconds.

In this case, it is preferable to apply 10³ W/kg to 10⁶ W/kg as energy dissipation (power) during the ultrasonic treatment.

The smectite-based clay minerals in the suspension can be nano-particle-treated in a micro-particle state by ultrasonically treating the suspension including the smectite-based clay minerals under the above-described conditions, thereby producing smectite-based clay mineral nano-particles.

Here, the smectite-based clay mineral nanoparticles may have a size of 10 nm to 10 μm, and may be prepared in a uniform nanoparticle size by ultrasonic treatment.

Accordingly, the present invention can simply prepare the suspension liquid having smectite-group clay mineral nanoparticles, that is, the drilling fluid based on the nano-clay mineral, and the preparation method can provide an advantage in that the production efficiency can be increased and the drilling fluid can be produced in large quantities in a short time.

The drying and powdering step (S30) is a step of drying and powdering the resultant product subjected to the ultrasonic wave treatment step (S20), that is, the suspension having the smectite-group clay mineral nanoparticles, and is a step of preparing the same in a powder type.

At this time, the drying and powdering step (S30) is a step of putting the suspension liquid having the smectite clay mineral nanoparticles in an oven, drying the same under the condition of 90° C. to 110° C., and then pulverizing the same using a blender or a mixer.

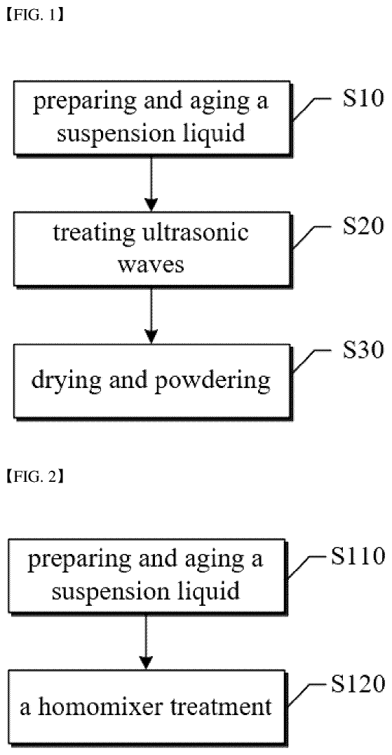

As shown in FIG. 2 and FIG. 3B, the method for preparing drilling fluid based on nano-clay minerals according to another embodiment of the present invention may include a suspension liquid preparation and aging step (S110) and a homomixer treatment step (S120).

The suspension liquid preparation and aging step (S110) is a step of mixing a smectite clay mineral with a solvent to prepare a suspension coal solution and aging the suspension coal solution for 24 hours to 48 hours for viscosity and dispersion stabilization.

The solvent may be used in an amount of 90 wt % to 99.9 wt %, and the smectite clay mineral may be mixed in an amount of 0.1 wt % to 10 wt %.

The smectite-based clay mineral may be one or more selected from the group consisting of bentonite, montmorillonite, saponite, hectorite, minnesotaite, nontronite, and beidelite.

The homomixer treatment step (S120) is a step of putting the suspension liquid containing the smectite-based clay minerals produced through the suspension liquid production and aging step (S110) into a homomixer and then mixing the same to nano-granulate the smectite-based clay minerals in the suspension liquid, thereby making the smectite-based clay mineral nano-particles.

In this case, the homomixer may have a blade-type or stator-rotor-type rotor.

Here, in the homomixer treatment step (S120), mixing may be performed for 2 hours to 4 hours under a condition of energy dissipation (power) 103 W/kg to 106 W/kg of the homomixer. Here, it is preferable that the homomixer is controlled at high speed at a rotation speed of 5000 rpm to 8000 rpm.

Accordingly, the smectite-based clay mineral nanoparticles may be prepared in a size of 10 nm to 10 μm, and may be prepared in a uniform nanoparticle size according to the homomixer treatment.

Therefore, it is possible to simply prepare the suspension liquid having smectite-group clay mineral nanoparticles, that is, the drilling fluid based on the nano-clay mineral, and such a preparation technique can also provide an advantage in that the drilling fluid can be mass-produced in a short time while enhancing preparation efficiency.

Meanwhile, hereinafter, the nano-clay mineral-based drilling fluid according to the present invention was prepared through a more specific embodiment, the rheological properties of the thus prepared drilling fluid were measured and shown, and the functionality according to the present invention will be described in detail with reference to FIGS. 3 to 15.

### Embodiments

### 1. Manufacturing of Normal Bentonite-Based Drilling Fluid

General bentonite was mixed in distilled water at a mass fraction of 3 wt % to 5 wt %, and physical properties were measured after aging for 48 hours according to American petroleum institute (API) regulations. This process is a process of waiting for the time when bentonite swells sufficiently.

### 2. Manufacturing of Nano-Bentonite-Based Drilling Fluid Through Ultrasonic Treatment

In the preparation of nano bentonite through ultrasonic treatment according to the present invention, probe ultrasonic equipment was used.

At this time, the mass fraction of bentonite in the suspension was 0.1~1.25 wt %, and the intensity of the ultrasonic wave was 60 to 70 W, and the ultrasonic wave was applied for 3 seconds, and the process was carried out for 2 hours to 4 hours with a cycle of resting for 2 seconds. After ultrasonication, it was placed in an oven at 100° C. and dried, and then prepared as nanobentonite powder through a general blender or mixer.

3. Manufacturing of Nano-Bentonite-Based Drilling Fluid Treated with a Stator-Rotor Type Homomixer

In the preparation of nano bentonite through the homomixer treatment according to the present invention, a sawtooth-shaped quadruple stator-rotor type homomixer equipment was used.

At this time, the mass fraction of bentonite in the suspension was 3~5 wt %, the energy dissipation of the homomixer was 10³ W/kg to 10⁶ W/kg depending on the number of revolutions, and the treatment time was carried out for 2 hours to 4 hours.

4. Manufacturing of Nano-Bentonite-Based Drilling Fluid Treated with a Blade-Type Homomixer

In the preparation of nano bentonite through the blade type homomixer treatment according to the present invention, a blade type homomixer equipment was used.

In this case, the size of the homomixer was 100 L, and the amount of the prepared bentonite suspension was 50 L. The concentration of bentonite in the suspension was 3~5 wt %, the energy dissipation of the homomixer was 10³ W/kg to 10⁶ W/kg depending on the number of revolutions, and the treatment time was carried out for 2 hours to 4 hours.

FIG. 4 is a photograph showing an electric field emission type scanning electron microscope image of nano-bentonite according to ultrasonic treatment in the method for manufacturing a drilling fluid based on nano-clay minerals according to the present invention.
(a) is a case of general bentonite which has not been treated, and it may be confirmed that the scale is about 1 to 10 microscale, (b) is a case in which the bentonite particles are distributed within 2 micrometers when the ultrasonic treatment time is within 2 hours, and it may be confirmed that the bentonite particle size is nanoscale when the ultrasonic treatment time is 4 hours.

Accordingly, it can be confirmed that the particles of bentonite can be made sufficiently small compared to the conventional process through ultrasonic treatment.

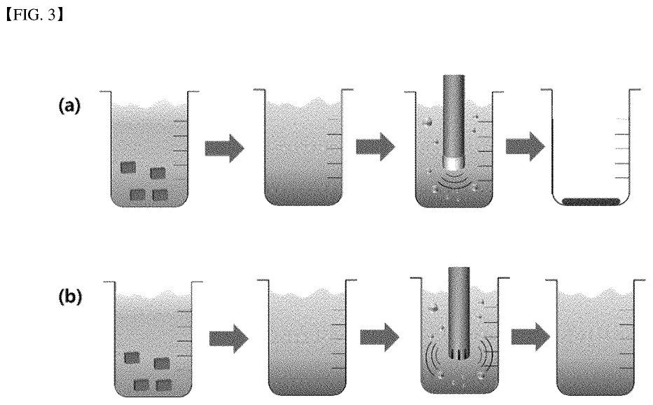

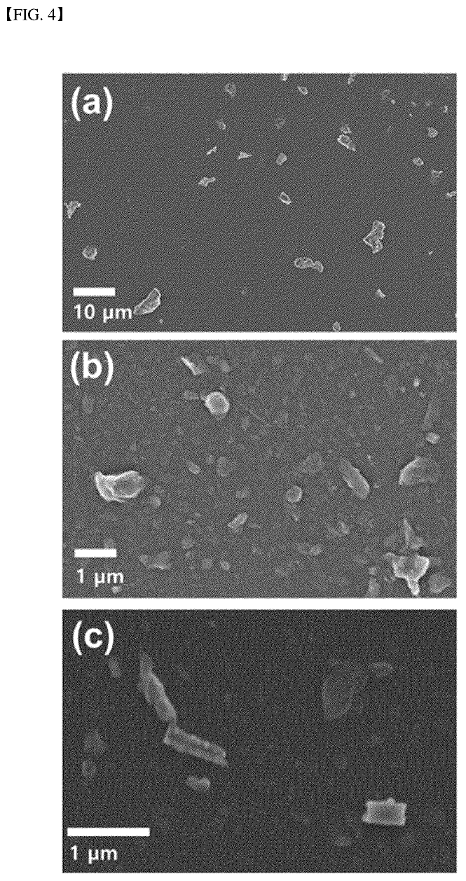

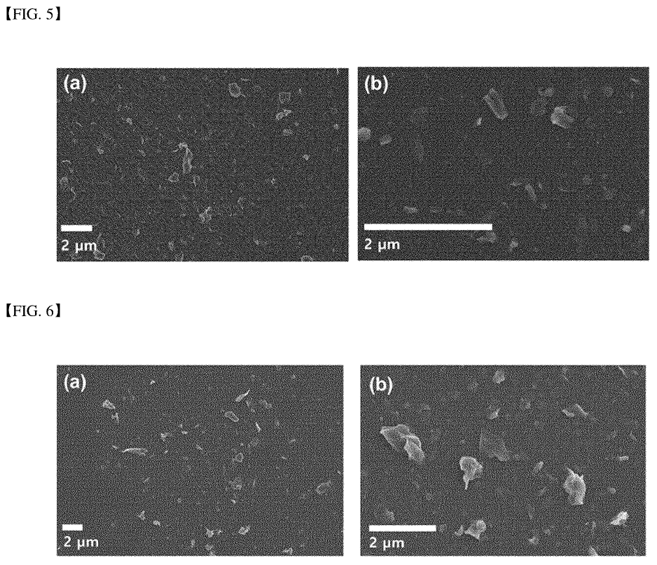

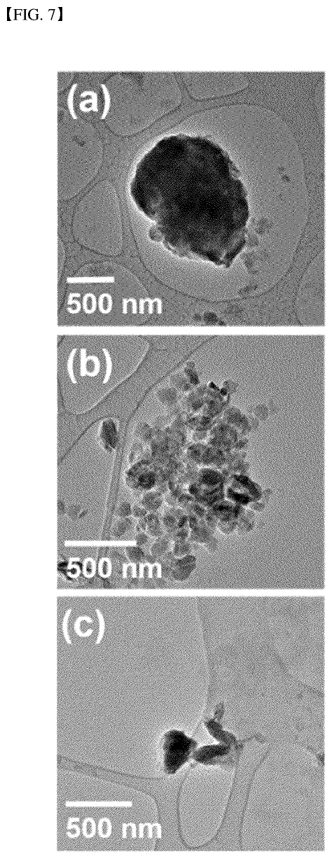

FIG. 5 is a photograph showing an electric field emission type scanning electron microscope image of nano-bentonite according to treatment of a stator-rotor type homomixer in the method for preparing drilling fluid based on nano-clay minerals according to the present invention.

It can be confirmed that bentonite particles treated within 2 hours are distributed within 2 micrometers in (a), and it can be confirmed that bentonite particles treated within 4 hours become nano-scale in (b).

Accordingly, it may be confirmed that bentonite may be manufactured in the nano-particle size like ultrasonic waves through the homomixer.

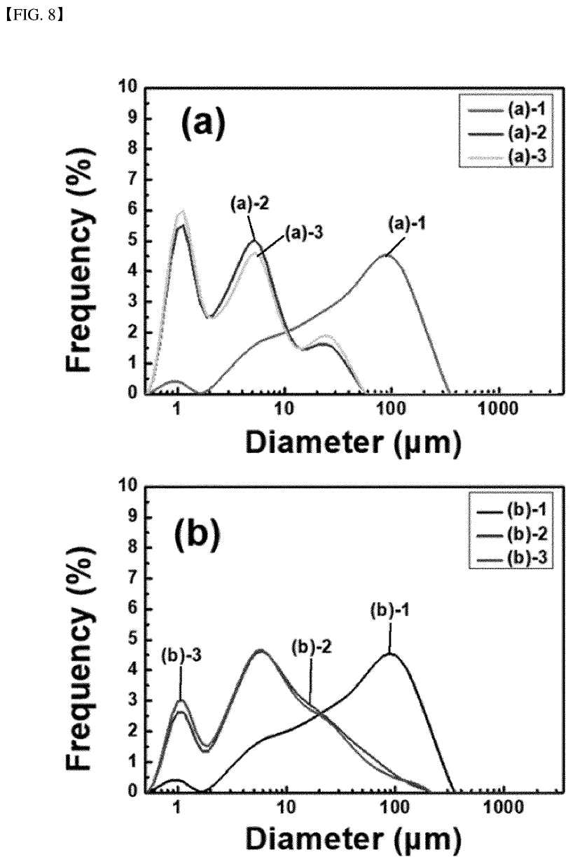

FIG. 6 is a photograph showing an electric field emission type scanning electron microscope image of nano bentonite according to the blade type homomixer treatment in the method for preparing drilling fluid based on nano-clay minerals according to the present invention.

It can be confirmed that bentonite particles treated within 2 hours are distributed within 2 micrometers in (a), and it can be confirmed that bentonite particles treated within 4 hours become nano-scale in (b).

Accordingly, it can be confirmed that bentonite can be produced as nanoparticles such as ultrasonic waves, and mass production is possible through mass production.

FIG. 7 is a photograph showing a transmission electron microscopy image of bentonite for comparison of the present invention, which is an image showing bentonite treated with normal bentonite and sonicated or homomixer treated.
(a) is a case of general bentonite, and when viewed from a transmission electron microscope, it can be confirmed that the smallest particle has a diameter of about 1 micrometer, (b) is a bentonite treated with ultrasonic waves for 4 hours and has a size of several tens of nanometers, and (c) is a bentonite treated with a homomixer of a stator-rotor type for 4 hours and has a size of several tens of nanometers.

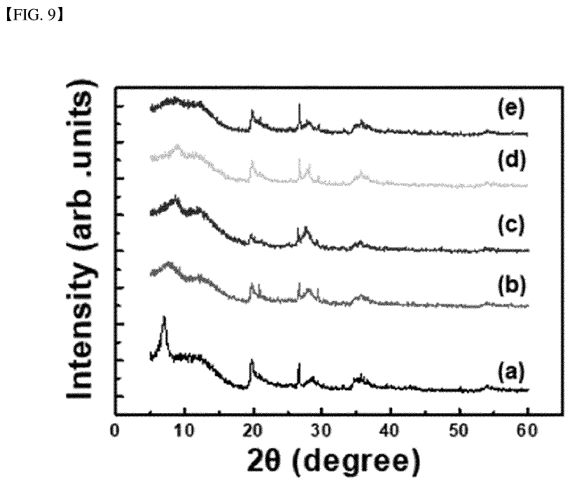

FIG. 8 is a graph showing a particle distribution of nano-bentonite according to the homomixer treatment in the method for preparing drilling fluid based on nano-clay minerals according to the present invention.
(a) is a graph treated with a stator-rotor type homomixer, and (b) is a graph treated with a blade type homomixer.

In the graph (a), (a-1) is normal bentonite, (a-2) is treated for 2 hours, and (a-3) is treated for 4 hours.

Here, it can be seen that the size of general bentonite {(a)-1} is variously distributed in the range of tens to hundreds of micrometers, whereas when the homomixer is treated for 2 hours {(a)-2} or 4 hours {(a)-2}, the particle size is significantly smaller than that of general bentonite, and it can be seen that the particle size is smaller as the treatment time of the homomixer increases.

Further, in the graph (b), (a-1) is normal bentonite, (a-2) is treated for 2 hours, and (a-3) is treated for 4 hours.

Here, as compared with the general bentonite {(b)-1}, it can be seen that when the homomixer is treated for 2 hours {(b)-2} or 4 hours {(b)-2}, the particle size is remarkably smaller than that of the general bentonite, and it can be seen that the particle size is smaller as the treatment time of the homomixer is increased.

FIG. 9 is a graph illustrating particle crystallinity of nano-bentonite by sonication or homomixer treatment in the method for preparing drilling fluid based on nano-clay minerals according to the present invention.

Here, (a) is a general bentonite treated without any treatment, (b) is a bentonite treated with a 2-hour ultrasonic wave, (c) is a bentonite treated with a 4-hour ultrasonic wave, (d) is a bentonite treated with a stator-rotor homomixer for 2 hours, and (e) is a graph showing an X-ray diffraction (XRD) of a bentonite treated with a blade-rotor homomixer for 4 hours.

In (a) without any treatment, peaks appeared at 20=6.9°, 19.6°, and 26.5°, and these peaks are XRD points of montmorillonite.

Even in the case of the XRD peak points of (b) to (e), some of them disappeared, but the peak still exists at the core points of 20=19.6° and 26.5°, suggesting that the crystallinity of bentonite is maintained even after the treatment with the ultrasonic wave or the homomixer.

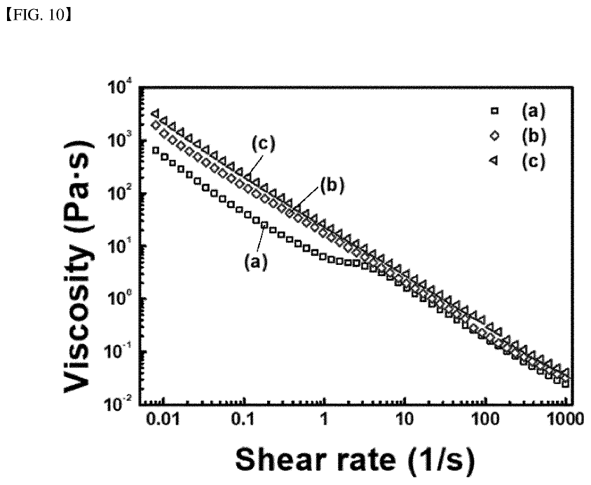

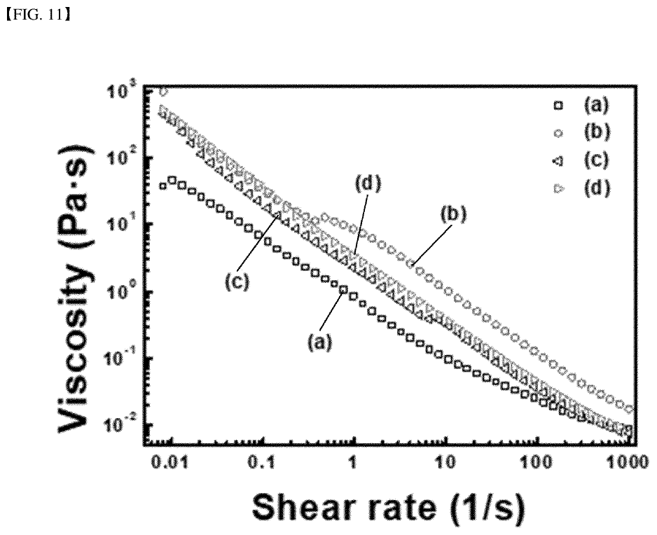

FIG. 10 is a graph showing a viscosity value according to shear stress of a drilling fluid produced by mixing a nano bentonite powder produced by ultrasonic treatment with distilled water in the method for producing a drilling fluid based on a nano-clay mineral according to the present invention.

Here, (a) is normal bentonite treated with no treatment, (b) is bentonite treated with ultrasonic waves for 2 hours, and (c) is bentonite treated with ultrasonic waves for 4 hours, wherein the viscosity according to the shear rate of drilling fluid prepared by mixing distilled water at a mass fraction of 5 wt % is measured.

Here, it could be confirmed that the overall viscosity increased linearly as the ultrasonic treatment time increased, compared to the sample (a). This is because the ultrasonic treatment increases the viscosity of drilling fluid by increasing the surface area relative to the mass as the particles of bentonite become smaller, and it can be confirmed that higher viscosity can be made with the same amount of bentonite.

FIG. 11 is a graph showing viscosity values according to shear stress of nano bentonite drilling fluid manufactured by processing a stator-rotor type homomixer in the method for manufacturing drilling fluid based on nano-clay minerals according to the present invention.

Here, (a) is normal bentonite of 3 wt % mass fraction without any treatment, (b) is normal bentonite of 5 wt % mass fraction without any treatment, (c) is bentonite of 3 wt % mass fraction treated with a stator-rotor type homomixer for 2 hours, and (d) is bentonite of 3 wt % mass fraction treated with a stator-rotor type homomixer for 4 hours.

Here, unlike the ultrasonic treatment, the homomixer shows that particles may be sufficiently made small even at a concentration of 3 wt % or more of bentonite, the homomixer has higher viscosity than the general bentonite sample (a) having a concentration of 3 wt % even at a concentration of 3 wt %, and has higher viscosity at a low shear rate as much as the general bentonite sample (b) having a concentration of 5 wt %. This can provide the advantage that if bentonite is manufactured in a nano-size with a homomixer, the desired viscosity can be sufficiently reached even with a concentration less than 5 wt %, and bentonite can be saved at the same time.

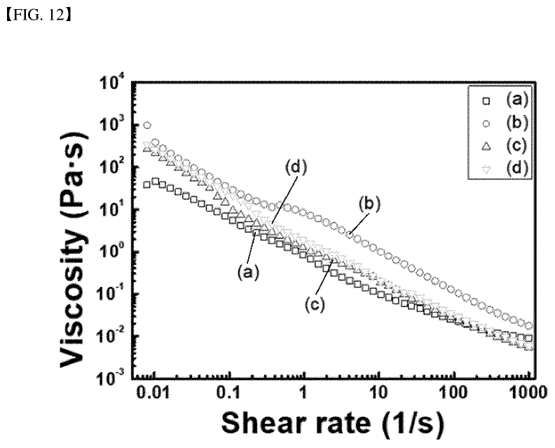

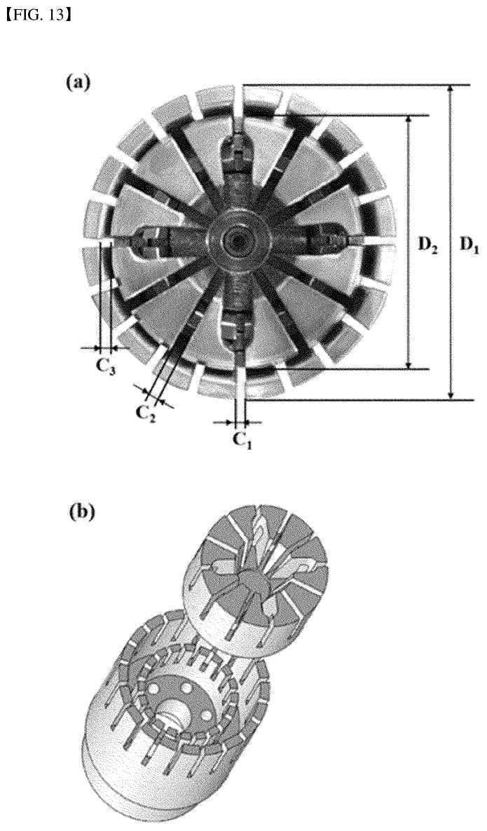

FIG. 12 is a graph showing a viscosity value according to shear stress of nano bentonite drilling fluid manufactured by blade-type homomixer treatment in the method for manufacturing the drilling fluid based on the nano-clay mineral according to the present invention.

Here, (a) is normal bentonite of 3 wt % mass fraction without any treatment, (b) is normal bentonite of 5 wt % mass fraction without any treatment, (c) is bentonite of 3 wt % mass fraction treated with a blade type homomixer for 2 hours, and (d) is bentonite of 3 wt % mass fraction treated with a blade type homomixer for 4 hours.

Here, the viscosity behaviors of the samples (c) and (d) are similar to those of the data processed with the stator-rotor type homomixer, and it is shown that the bentonite particles can be manufactured in small sizes and the viscosity of the drilling fluid can be increased.

### 5. Comparison of Quantification of Shear Thinning in Drilling Fluid

The drilling fluid generally has high viscosity at a low shear stage and low viscosity at a high shear stage, that is, as the viscosity rapidly decreases according to the shear rate, it can be seen that the performance is good as the drilling fluid. In order to express this numerically, the following work was carried out.

In order to quantitatively compare the rheological properties measurement results and numerically compare the shear thinning phenomenon in which the viscosity decreases according to the shear rate, a simple power law capable of expressing the shear rate and the viscosity was applied. In the log scale, k is a constant that makes the total value increase constantly, and n means a slope, and as n decreases, the viscosity decreases rapidly, and the shear thinning phenomenon tends to appear remarkably. When the rheological properties of Examples and Comparative Examples were measured, the viscosity value according to the shear rate was curve fitting and expressed by a formula to perform quantitative comparison, and the results of calculating the n value are shown in the table below.

$$y = k \times {x}^{( n - 1 )} [ a general power - law model ]$$

Here, y denotes viscosity, and x denotes a shear rate. k and n are constants)

TABLE 1

| | | Processing | Processing | Fitting gradient function, |
|---|---|---|---|---|
| Sample | Concentration | method | time | the value of n |
| Example 1 | 5 wt % | None | None | y = 6.4144x-0.853, n = 0.147 |
| Example 2 | 3 wt % | None | None | y = 0.9086x-0.784, n = 0.216 |
| Example 3 | 5 wt % | Ultrasonic | Two hours | y = 17.186x-0.931, n = 0.069 |
| | | treatment | | |
| Example 4 | 5 wt % | Ultrasonic | Four hours | y = 26.841x-0.951, n = 0.049 |
| | | treatment | | |
| Example 5 | 3 wt % | Homomixer A | Two hours | y = 2.6321x-0.929, n = 0.071 |
| Example 6 | 3 wt % | Homomixer A | Four hours | y = 3.8099x-0.964, n = 0.036 |
| Example 7 | 3 wt % | Homomixer B | Two hours | y = 1.7758x-0.915, n = 0.085 |
| Example 8 | 3 wt % | Homomixer B | Four hours | y = 2.4706x-0.943, n = 0.057 |

Here, the homomixer A is a stator-rotor type homomixer, and the homomixer B is a blade type homomixer. When comparing Example 1 in which nothing was treated with Examples 3 and 4 in which ultrasonic treatment was performed, it can be confirmed that the value of n decreases as the ultrasonic treatment time increases. This shows through quantitative comparison that the shear thinning phenomenon is strengthened as the ultrasound treatment time increases.

In addition, comparing Example 2 treated with nothing with Examples 5 and 6 treated with the homomixer and Examples 7 and 8 treated with the homomixer, it can be seen that the value of n linearly decreases with an increase in the processing time of the homomixer.

In conclusion, it can be confirmed from numerical data through fitting that shear thinning is strengthened when bentonite is manufactured to have a nano-particle size through the treatment with the ultrasonic wave or the homomixer according to the present disclosure.

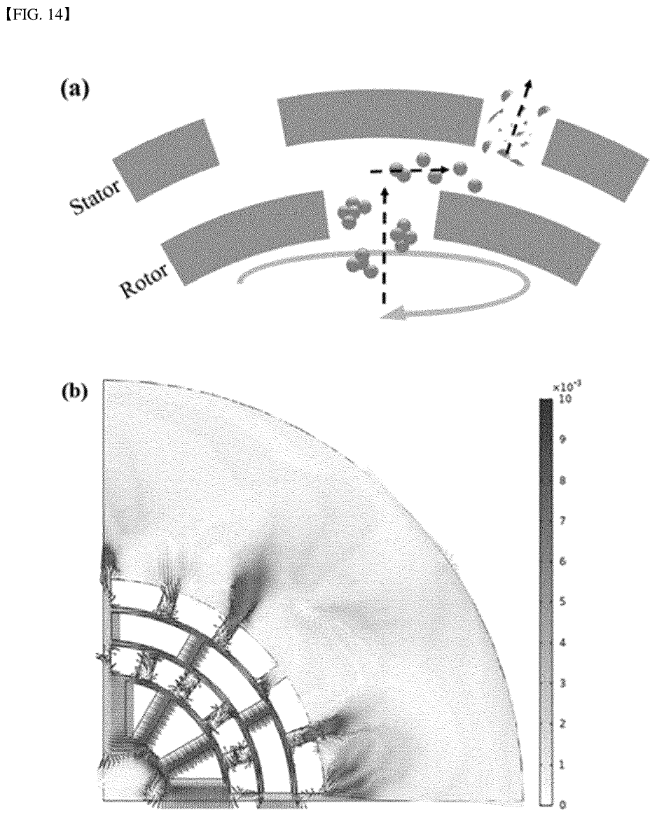

Meanwhile, FIGS. 13 and 14 are views illustrating the method of manufacturing drilling fluid based on nano-clay minerals according to the present invention, in which a stator-rotor type homomixer is used, and as shown in FIG. 13, a stator-rotor type homomixer is used with respect to a rotation part and a rotation speed of 6000 rpm is applied thereto.

Here, the diameter of the stator is 40.6 [mm], the diameter of the rotor is 33 [mm], the interval of the stator is 1.3 [mm], the interval of the rotor is 1.4 [mm], and the interval between the stator and the rotor is 0.8 [mm].

In addition, as shown in FIG. 13(b), the three-dimensional structure of the stator-rotor has several layers of shear gaps formed by the stator and the rotor, and this causes strong turbulent shear stress due to high-speed rotation and turbulent jet is formed along the gap of the stator, thereby dispersing the bentonite particles and performing the nano-sizing of the particles.

FIG. 14 is a view showing numerical analysis results for confirming the above-described mechanism on the side of a stator-rotor type homomixer in the present invention.

Flow numerical analysis was performed using COMSOL Multiphysics 5.5 in order to check data such as turbulent jet and turbulent stress generated by the homomixer, and in the case of the homomixer, since it has a periodic shape and there was no difference in results when compared with the results of analyzing the overall shape, only the area of ¼ was analyzed.

Here, in the case of the boundary condition, the rotor part was set to rotating domain to give a rotational speed, and in the case of the wall on the side, rotational periodicity boundary condition was set. Due to the characteristics of the homomixer, when the rotor makes a high-speed rotation, the internal fluid is pushed out, and the solids and liquid under the homomixer enter the homomixer and are discharged to the outside together with a strong jet. Therefore, the upper and lower surfaces were used to allow fluid to enter the inside of the homomixer and form jets using the boundary stress free condition.

FIG. 14(b) shows a flow pattern of the drilling fluid of nano bentonite having a concentration of 5 wt % at a rotation speed of 6,000 rpm, wherein the flow pattern from the velocity field at a point having a height of ⅔ from the bottom at xy plane. includes jets and turbulence. The first and third teeth from the center are rotors, and the second and fourth teeth are stators, wherein the rotor, which is the first tooth that is close to the center, rotates to face the end portion of the stator, which is the second tooth, and thus flow is discharged, and as the rotor, which is the third tooth, collides with the rotor, a circulating flow occurs, and as the rotor, which is the third tooth, rotates, it comes into contact with the end of the stator that is farthest from the center, thereby releasing the turbulent jet.

That is, in the present invention, it can be confirmed that the bentonite particles are dispersed through the homomixer treatment and the nanoization of the particles can be performed.

The above-described embodiments are merely illustrative of preferred embodiments of the present invention and are not extremely limited to such embodiments, and various modifications, variations, or step substitutions may be made by those skilled in the art within the technical spirit and claims of the present invention, which falls within the technical scope of the present invention.

### INDUSTRIAL APPLICABILITY

The present invention relates to a nano-clay mineral-based drilling fluid and a method for preparing the same, wherein the drilling fluid provides a nano-clay mineral-based drilling fluid, wherein the drilling fluid can increase viscosity with respect to an equal weight to be used, can improve shear thinning, and allows the use of a small amount when compared to an existing one, while having improved physical properties with a higher concentration.

1. A drilling fluid based on a nano-clay mineral comprising:
a solvent and smectite-group clay mineral nanoparticles,
wherein the solvent is distilled water or salt water, and the smectite-group clay mineral nanoparticles have a size of 10 nm to 10 micrometers.

2. The drilling fluid based on nano-clay minerals of claim 1,
wherein the solvent is 90 wt % to 99.9 wt % and the smectite clay mineral nanoparticles are mixed at 0.1 wt % to 10 wt %.

3. The drilling fluid based on nano-clay minerals of claim 1,
wherein the smectite-based clay minerals are one or more selected from the group consisting of bentonite, montmorillonite, saponite, hectorite, minnesota, nontronite, and beidelite.

4. The nano-clay mineral-based drilling fluid according to claim 1,
wherein the drilling fluid is a powder type or a liquid type.

5. A method of manufacturing drilling fluid based on nano-clay minerals,
the method comprising: (A) mixing the smectite-based clay minerals with a solvent to prepare a suspension liquid, followed by aging for 24 hours to 48 hours for viscosity and dispersion stabilization; and (B) adding the suspension liquid to an ultrasonic wave ratio, followed by sonicating the suspension liquid at an ultrasonic intensity of 60 W to 70 W for 2 hours to 10 hours to nano-particulate the smectite-based clay minerals in the suspension liquid, thereby making smectite-based clay mineral nanoparticles.

6. The method of manufacturing drilling fluid based on nano-clay minerals of claim 5, further comprising: (C) drying and pulverizing the suspension liquid having the smectite-group clay mineral nanoparticles.

7. The method of manufacturing drilling fluid based on nano-clay minerals of claim 5,
wherein in step (A), 97 wt % to 99 wt % of the solvent and 0.1 wt % to 3 wt % of the smectite-based clay minerals are mixed.

8. The method of manufacturing drilling fluid based on nano-clay minerals of claim 5,
wherein the smectite-based clay mineral is at least one selected from the group consisting of bentonite, montmorillonite, saponite, hectorite, minnesotaite, nontronite, and beidelite.

9. The method of manufacturing drilling fluid based on nano-clay minerals of claim 5,
wherein in step (B), energy dissipation during the ultrasonic treatment is 103 W/kg to 106 W/kg.

10. The method of manufacturing drilling fluid based on nano-clay minerals of claim 5,
wherein the smectite-based clay mineral nanoparticles have a size of 10 nm to 10 micrometers.

11. The method of manufacturing drilling fluid based on nano-clay minerals according to claim 6,
wherein in step (C), the suspension liquid having smectite clay mineral nanoparticles is dried in an oven at 90° C. to 110° C. and then powdered using a blender or a mixer.

12. A method of manufacturing drilling fluid based on nano-clay minerals,
the method comprising the steps of: (A) mixing a smectite-based clay mineral with a solvent to prepare a suspension liquid, followed by aging for 24 to 48 hours for viscosity and dispersion stabilization; and (B) adding the suspension liquid to a homomixer, followed by mixing for 2 to 4 hours to nano-particulate the smectite-based clay mineral in the suspension liquid to make smectite-based clay mineral nanoparticles.

13. The method of manufacturing drilling fluid based on nano-clay minerals of claim 12,
wherein in the step (A), a 90 wt % to 99.9 wt % solvent and a 0.1 wt % to 10 wt % smectite clay mineral are mixed.

14. The method of manufacturing drilling fluid based on nano-clay minerals of claim 12,
wherein the smectite-based clay mineral is one or more selected from the group consisting of bentonite, montmorillonite, saponite, hectorite, minesotite, nontronite, and beidelite.

15. The method of manufacturing drilling fluid based on nano-clay minerals of claim 12,
wherein the smectite-based clay mineral nanoparticles have a size of 10 nm to 10 micrometers.

16. The method of manufacturing drilling fluid based on nano-clay minerals of claim 12,
wherein the homomixer has a blade-type or stator-rotor-type rotating part.

17. The method of manufacturing drilling fluid based on nano-clay minerals of claim 12,
wherein the step (B) is performed under a condition of energy dissipation of a homomixer of 103 W/kg to 106 W/kg.
